(19) United States
(12) Patent Application Publication
(10) Pub. No.: US 2015/0046568 A1
(43) Pub. Date: Feb. 12, 2015

(54) METHOD AND SYSTEM FOR PLAYING MULTICAST OVER-THE-TOP (OTT) CONTENT STREAMS

(71) Applicant: imVision Software Technologies Ltd., Ramat Gan (IL)

(72) Inventor: Sharon Mantin, Tel Aviv (IL)

(73) Assignee: imVision Software Technologies Ltd., Ramat Gan (IL)

(21) Appl. No.: 14/456,301

(22) Filed: Aug. 11, 2014

Related U.S. Application Data
(60) Provisional application No. 61/864,608, filed on Aug. 11, 2013.

(51) Int. Cl. H04L 29/06; H04L 29/08

(52) U.S. Cl. CPC H04L 65/60; H04L 67/02
USPC 709/219

(57) ABSTRACT

A method and system for multicast transmission of OTT streams to players that do not support multicast format are provided. The method includes establishing a transmission control protocol (TCP) connection with a media player; establishing a user datagram protocol (UDP) connection with a multicast delivery server (MDS); receiving an OTT content stream in a multicast streaming format via the UDP connection; reformatting the received multicast OTT content stream into a unicast stream; and delivering the unicast stream via the TCP connection to the media player, wherein the unicast stream is a streaming format supported by the media player.

### CROSS REFERENCE TO RELATED APPLICATIONS

This application claims the benefit of U.S. Provisional Application No. 61/864,608 filed Aug. 11, 2013, the contents of which are incorporated by reference.

### TECHNICAL FIELD

The invention relates generally to the delivery of over-the-top (OTT) content in communication networks and, more particularly, to providing multicast transmissions to media players that do not support multicast streaming.

### BACKGROUND

The world of digital delivery of multimedia content to viewers has been rapidly progressing. Typical types of multimedia content include video clips, electronic games, and interactive content. The delivery process for such multimedia content, particularly those transmitted in the form of video, may entail use of a variety of delivery standards, video quality levels, and other parameters. The techniques used in traditional television (TV) broadcast cannot be effectively used in the more modern multi-standard digital TV arena. Currently, only piecemeal solutions are available for efficient and seamless delivery of such multimedia content, to the arena of digital TV.

Specifically, content delivery is currently performed using two approaches: legacy content distribution and over-the-top (OTT) content distribution. Legacy content providers include, for example, cable, satellite, and internet protocol TV (IPTV) providers. Typically, such providers have full control over the entire delivery chain, from a central location from where the content is originated and transmitted (head-end) through the network to the end user's device (e.g., a set-top box). Therefore, legacy content providers can manage and guarantee efficient content delivery mechanisms and high Quality of Experience (QoE) to the end user.

Over-the-top (OTT) content distribution is the delivery of audio, video, and other types of multimedia content over the Internet without any control of the content distribution by the network operators and/or by the content providers. The providers of OTT content are third party providers which utilize the network's infrastructure to provide content to their subscribers. As such, OTT content providers are not responsible for controlling redistribution of the content. Examples for OTT content providers are Hulu®, Netflix®, and the like.

In most cases, OTT content providers control only the edges of a content distribution network. These edges are streaming servers at the head-end and the media players installed in user devices. However, as noted above, OTT content providers have no control over the distribution network. Rather, such providers merely utilize the network's infrastructure to deliver content. As such, OTT content providers are not responsible for the overall efficiency of OTT content distribution over the network and, as such, cannot guarantee high QoE to their subscribers.

The popularity of OTT services downgrades the performance of the communication networks managed by internet service providers (ISPs). Specifically, OTT content delivery significantly increases the bandwidth consumption in such networks. As a result, ISPs cannot ensure high Quality of Services (QoS) to their subscribers, thereby forcing ISPs to upgrade their networks to support the increased demand for bandwidth. In addition, congested networks cause higher packets loss and longer packet delays, thereby downgrading the QoE of OTT streaming services.

In OTT content delivery, the ISP is typically only responsible for transporting Internet protocol (IP) packets to users with no commitment for QoE parameters such as delay or packet loss. As noted above, increased popularity of OTT delivery leads to increased bandwidth consumption for ISP providers. Thus, as OTT delivery increases, the ISP may suffer from rapid growth in network bandwidth usage. Consequently, the ISP must invest significant amounts of resources in upgrading its network capacity to meet demands. OTT content providers face similar problems- the rapid growth in demand for OTT content has a direct impact on the traffic load associated with those providers and leads to bottlenecks in the ISP's network, thereby resulting in higher packets loss and longer packets delays.

FIG. 1 is a diagram of a system 100 illustrating the operation of end-to-end over-the-top (OTT) media streaming services operable over a communication network. In the system 100, OTT media content is streamed from the OTT content server to a user equipment device (UED) 110 through a broadband network 150 connected to the UED 110 and the Internet 155 connected to an OTT content server 170.

The UED 110 includes an operating system 120, a browser or application 130, and a media player 140. The UED 110 may be, for example, a laptop, a tablet, a smartphone, a smart television, and so on. The operating system 120 may be, for example, Windows®, Android®, iOS®, and so on. A browser (or any dedicated application) 130 provides access to a web portal (not shown) of the OTT content provider hosted by the web server 160 via a point-to-point connection 165.

The media player 140 plays the streams provided by the web server 160. The media player 140 may be, e.g., Flash Media Player, JW Player, HTML Player, and so on. The media player 140 is typically provided to the user by an OTT content provider. That is, the media player 140 is often programmed to handle streams and connections supported by the content provider or by its CDN.

To retrieve the requested content, the media player 140 initiates a session with the OTT content server 170 using a pre-defined streaming protocol. Such a protocol includes, for example, a real-time messaging (RTMP) protocol, a real-time streaming protocol (RTSP), a HTTP live streaming (HLS) protocol, a HTTP dynamic streaming (HDS) protocol, a moving pictures expert group dynamic adaptive streaming over HTTP (MPEG-DASH), and so on.

The media player 140 and the OTT content server 170 open a point-to-point connection 175 through which the OTT content server 170 streams the requested OTT content to the player 140. The media player 140 plays back the requested content on the UED 110. In parallel, the media player 140 opens another point-to-point connection 185 with an advertisement server 180. The advertisement server 180 is typically owned by an Advertising (Ad) Network and contains advertisements to be inserted into the OTT content. The media player 140 also opens a third point-to-point connection 195 with a statistic server 190 in order to report data regarding the content consumption.

FIG. 2 is a schematic block diagram of the UED 110 for unicast content delivery. The UED 110 includes a media player 140, an Internet protocol (IP) stack 220, a network interface 210, and sockets 215 and 225. The media player 140 initiates a transmission control protocol (TCP) connection with the OTT content server 170 (not shown in FIG. 2). Upon establishment of the TCP connection, the media player 140 and the server 170 utilize streaming protocols to stream OTT content to the physical layer 210.

To send and receive data to and from a network, the media player 140 opens a socket 225 to the UED 110's operating system 120 via the unicast communication module 220. To this end, the media player 140 may provide information regarding its streaming protocol port ID (i.e., the source port's ID) as well as regarding the URL and streaming protocol port ID of the destination (i.e., the destination IP address and port).

The unicast communication module 220 receives all information sent by the media player 140 through the socket 225, generates IP packets, and sends such IP packets to a network (not shown) through a socket 215 and the network interface 210. Additionally, the unicast communication module 220 receives all information sent to the UED 110 through the physical layer 210 and socket 215, de-capsulates the IP headers, and sends the data to the media player 140 over the socket 225. The socket 225 is a TCP socket for OTT content streams.

Currently most OTT services are delivered over a dedicated point-to-point connection (i.e., a unicast connection) between the OTT content server located at the OTT content provider or CDN and the UED. This unicast connection may be effective for delivering on-demand OTT content due to the lack of correlation between contents consumer by different users at various points in time (i.e., because users do not necessarily access the same content or portions of content at the same or similar times).

In the case of live or linear OTT content services, however, a point-to-point delivery is not particularly efficient, as all users consume the same content simultaneously. In such instances, a point-to-multipoint (i.e., multicast) delivery method is often more efficient.

In spite of the inefficiency of unicast delivery mechanisms for delivering live or linear OTT content services, due to a lack of collaboration between the OTT content providers or CDNs and the ISPs, ISPs frequently do not permit multicast delivery mechanisms for OTT live and linear services. Such multicast delivery mechanisms require configuration of routers, switches, and other network elements to support multicast formats. However, these network elements are not controlled by the OTT content providers or CDNs.

Furthermore, the media players provided by the OTT content providers (e.g., media player 140) are frequently only designed to support only unicast delivery methods. In many cases, these players do not support multicast delivery methods of OTT content delivery.

Additionally, each OTT content provider typically utilizes its own version of a media player, and such versions of OTT players are often modified by the OTT content providers. As a result, tracking such OTT players and modifying them in real-time can be a very costly and complicated endeavor for network operators, such that those network operators may be forced to use unicast delivery methods rather than multicast delivery methods due to the degraded network efficiency of such tracking.

It would be therefore advantageous to provide a solution that overcomes the deficiencies of prior art solutions by permitting multicast transmissions to media players that do not support multicast streaming. It would further be advantageous if such a solution does not require modification of different OTT players in UEDs.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all embodiments. Its sole purpose is to present some concepts of one or more embodiments in a simplified form as a prelude to the more detailed description that is presented later. For convenience, the term some aspects may be used herein to refer to a single aspect or multiple aspects of the disclosure.

The disclosure relates in various embodiments to a method for playing over-the-top (OTT) content streams. The method includes establishing a transmission control protocol (TCP) connection with a media player; establishing a user datagram protocol (UDP) connection with a multicast delivery server (MDS); receiving an OTT content stream in a multicast streaming format via the UDP connection; reformatting the received multicast OTT content stream into a unicast stream; and delivering the unicast stream via the TCP connection to the media player, wherein the unicast stream is a streaming format supported by the media player.

The disclosure also relates in various embodiments to a system for playing over-the-top (OTT) content in a multicast streaming format. The system includes a processor; and a memory communicatively connected to the processor, the memory containing instructions that, when executed by the processor, configure the system to: establish a transmission control protocol (TCP) connection with a media player; establish a user datagram protocol (UDP) connection with a multicast delivery server (MDS); receive an OTT content stream in a multicast streaming format via the UDP connection; reformat the received multicast OTT content stream into a unicast stream; and deliver the unicast stream via the TCP connection to the media player, wherein the unicast stream is a streaming format supported by the media player.

The disclosure also relates in various embodiments to a communication terminal including a display; a processing unit; and a memory, the memory containing instructions that, when executed by the processing unit, configure the terminal to: establish a transmission control protocol (TCP) connection with a media player; establish a user datagram protocol (UDP) connection with a multicast delivery server (MDS); receive an OTT content stream in a multicast streaming format via the UDP connection; reformat the received multicast OTT content stream into a unicast stream; and deliver the unicast stream via the TCP connection to the media player, wherein the unicast stream is a streaming format supported by the media player, thereby enabling the media player to display the contents of the unicast stream over the display.

The disclosure also relates in various embodiments to a method for playing over-the-top (OTT) content streams. The method comprises establishing a user datagram protocol (UDP) connection with a multicast delivery server (MDS); receiving an OTT content stream in a multicast streaming format via the UDP connection; receiving a request for content from a media player, wherein the request is a hypertext transfer protocol (HTTP) Get request; and responding to the request with data received via the UDP connection.

### BRIEF DESCRIPTION OF THE DRAWINGS

The subject matter disclosed herein is particularly pointed out and distinctly claimed in the claims at the conclusion of the specification. The foregoing and other objects, features, and advantages of the embodiments disclosed herein will be apparent from the following detailed description taken in conjunction with the accompanying drawings.

FIG. 1 is a schematic diagram an end-to-end OTT content service operable over telecommunication and internet networks (Prior Art).

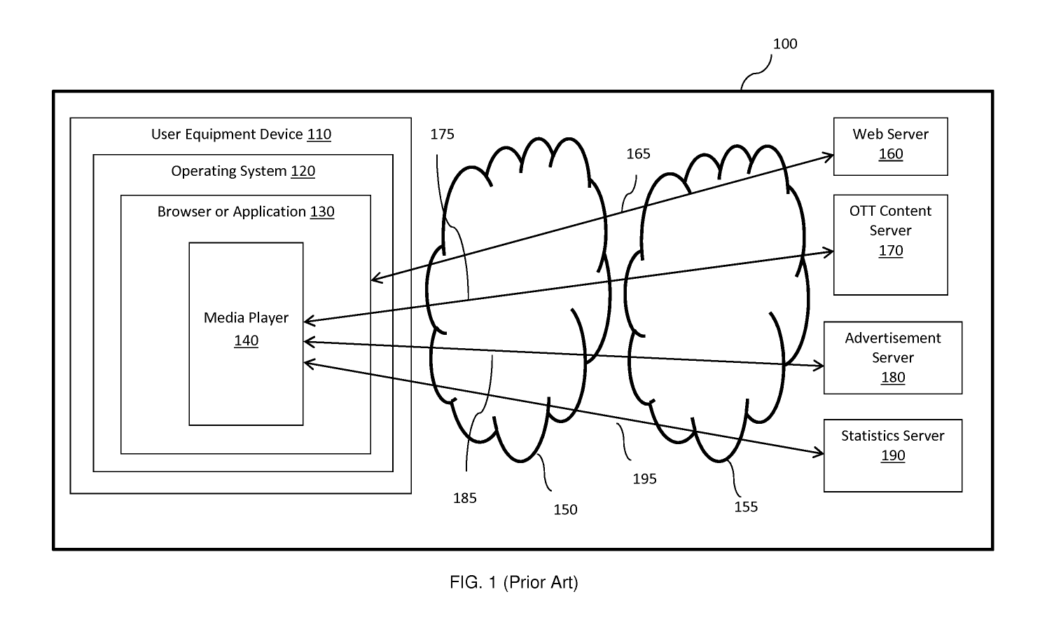

FIG. 2 is a schematic block diagram of a user equipment device for unicast content delivery (Prior Art).

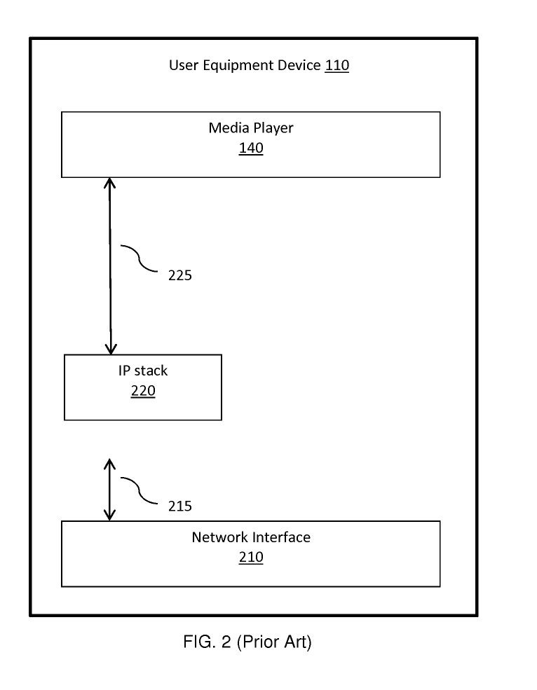

FIG. 3 is a content distribution network utilized to describe the disclosed various embodiments.

FIG. 4 is a schematic block diagram of a user equipment device for supporting OTT multicast content delivery according to an embodiment.

FIG. 5 is a schematic block diagram of a content proxy according to an embodiment.

FIG. 6 is a flowchart illustrating the delivery of content in a multicast stream to media players that are not configured to play multicast streams according to an embodiment.

FIG. 7 is a schematic block diagram of a content proxy according to another embodiment.

### DETAILED DESCRIPTION

Various embodiments of the disclosure are described below. It should be apparent that the teachings herein may be embodied in a wide variety of forms and that any specific structure, function, or both being disclosed herein is merely representative. Based on the teachings herein, one skilled in the art should appreciate that an embodiment disclosed herein may be implemented independently of any other embodiments and that two or more of these embodiments may be combined in various ways. For example, an apparatus or a system may be implemented or a method may be practiced using any number of the embodiments set forth herein. In addition, such an apparatus or system may be implemented or such a method may be practiced using other structure, functionality, or structure and functionality in addition to or in place of one or more of the embodiments set forth herein. Furthermore, any aspect disclosed herein may be embodied by one or more elements of a claim.

The embodiments disclosed herein are examples of the many possible advantageous uses and implementations of the innovative teachings presented herein. In general, statements made in the specification of the application do not necessarily limit any of the various disclosed embodiments. Moreover, some statements may apply to some inventive features but not to others. In general, unless otherwise indicated, singular elements may be in plural and vice versa with no loss of generality. In the drawings, like numerals refer to like parts through several views.

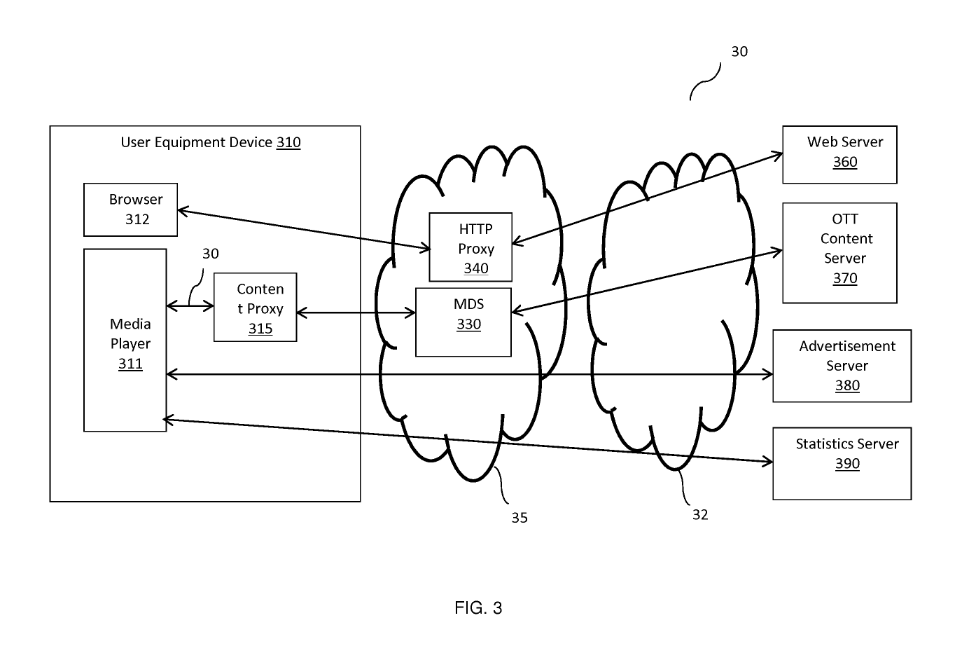

FIG. 3 is an exemplary and non-limiting diagram of a content distribution network 300 utilized to describe the various embodiments disclosed herein. In an exemplary implementation, the content distribution network 300 includes a user equipment device (UED) 310 configured to play content (e.g., video content) streamed by an OTT content provider from an OTT content server 370. The UED 310 may be, but is not limited to, a personal computer (PC), a smart phone, an electronic kiosk, a tablet computer, a wearable computing device, a smart TV, and the like. The UED 310 is configured to execute a media player 311 from any one of a web-browser, an application (e.g., a mobile app), and the like.

The UED 310 is further communicatively connected to a broadband network 350. In an exemplary embodiment, the broadband network 350 may include a fixed-line network, a cellular network or a combination thereof. Typically, the broadband network includes several network elements including, but not limited to, switches, routers, digital subscriber line access multiplexers (DSLAMs), cable modem termination systems (CMTS), base transceiver stations (BTS), and so on, through which the end user sends and receives data to and from the Internet. A fixed-line network may include infrastructure such as, but not limited to, cable, fiber optic, digital subscriber line (DSL), or any other communication network allowing connectivity of end users to the Internet. A fixed-line network is typically operated by any of an internet service provider (ISP), a telecom network provider, a cable television (TV) provider, and the like. A cellular network may be operated according to a communication protocol including, for example, the WCDMA, TD-CDMA, TD-SCDMA, and LTE. It should be noted that the connectivity of UEDs such as UED 310 to the broadband network 350 is typically through a local area network (LAN), a wireless LAN (WLAN), and the like.

At the other end of the system, the OTT content server 370 is also communicatively connected to a multicast delivery system (MDS) 330 through a communication network 320. The network 320 may be a local area network, a wide area network (WAN), a metropolitan area network (MAN), the Internet, and the like. The OTT content server 370 locally hosts or receives the multimedia content from its origin (e.g., a studio, not shown) in real-time. The OTT content server 370 is configured to stream this content as an OTT content stream to the end user over the networks 320 and 350. OTT content servers (e.g., OTT content server 370) are typically deployed in datacenters in different geographical locations. Although not shown in FIG. 3, OTT content servers are typically connected to content distribution networks (CDNs).

The MDS 330 is configured to generate an OTT content stream in a multicast format from a unicast stream. The unicast stream may be a live, linear, replicated, or other type of stream that can be multicasted. The multicasting allows for improvement of the efficiency of the broadband network. For example, if a live OTT stream of a basketball game is currently being watched by 1000 users over their respective UEDs, then the MDS 330 is configured to generate and deliver one multicast OTT stream instead of 1000 unicast OTT streams individually streamed to the UEDs. If the MDS 330 determines that the delivery of the multicast-able OTT stream in its multicast format would likely improve the performance of the broadband network, then such stream may be directly delivered to the UEDs. An example for the operation of the MDS 330 can be found in U.S. patent application Ser. Nos. 14/341,025 and 14/446,880, assigned to the common assignee, and hereby incorporated by reference for all that they contain.

A web server 360 is also communicatively connected to the UED 310 through an HTTP proxy 340. The web server 360 hosts a web portal for the content that can be viewed. A user of the UED 310 can interact with the web portal using a browser 312 (or an application installed in the UED 310). Upon selection of content to stream, the media player 311 may retrieve and play back the stream. The media player 311 may be, for example, Flash Media Player, JW Player, HTML Player, and so on. The media player 311 is typically provided to the user by an OTT content provider or CDN.

According to the disclosed embodiments, a content proxy 315 is implemented in the UED 310. The content proxy 315 is connected to the media player 311 and configured to provide the OTT stream in a format that can be decoded and played by the media player 311. The OTT streams that the content proxy 315 receives may be in a unicast format and/or a multicast format. The format of the stream received by the content proxy 315 may not be the format supported by the OTT provider and the media player 311. Therefore, the content proxy 315 at least allows playing OTT streams in a multicast format over media players that do not support such formats. As the content proxy 315 is not part of the media player 311, its operation is seamless to the player. In addition, the operation of the content proxy 315 does not require any modification to the media player 311.

In an embodiment, the content proxy is implemented as an add-on in the browser 312. In another embodiment, the HTTP proxy 340 intercepts data transmitted between the browser 312 and the web server 360 in order to modify the content of a requested web page to include a link to download the content proxy 315 to the browser 312 or to the UED 310. The content proxy is compatible with an operating system (not shown) of the UED 310, which may include, for example, Windows®, Android®, iOS®, and the like.

To retrieve the requested content, the media player 311 initiates a session with the OTT content server 370 over a point-to-point TCP connection using one of a pre-defined streaming protocol. The streaming protocol may be, for example, a real-time messaging (RTMP) protocol, a real-time streaming (RTSP) protocol, a HTTP live streaming (HLS) protocol, a HTTP dynamic streaming (HDS) protocol, moving pictures expert group dynamic adaptive streaming over HTTP (MPEG-DASH), and so on.

According to one embodiment, the MDS 330 is configured to intercept a request to initiate the session and instruct the media player to redirect the request to the context proxy 315. In response, the media player 311 re-initiates a session with the content proxy 315 in order to retrieve the OTT content over a point-to-point TCP connection using the same streaming protocol the media player intends to use with the OTT content server 370.

The content proxy 315 is configured to establish a UDP connection with the MDS 330 to retrieve OTT streams in a multicast format. In addition, the content proxy 315 may retrieve information related to a streaming protocol port ID at the MDS 330, an IP multicast group (multicast IP address of the requested content), and a streaming protocol port ID.

In another embodiment, the content proxy 315 is configured to re-format the streams received from the MDS 330 from a multicast format to a unicast format supported by the media player 311. The unicast stream is provided to the player 311 to be displayed thereon.

According to various exemplary embodiments, a unicast format may include, but is not limited to, a real time messaging protocol (RTMP), a HTTP live streaming (HLS) protocol, or any other streaming protocol over a transmission control protocol (TCP) connection. A multicast format of an OTT stream may include, but is not limited to, real time streaming protocol (RTSP) over user datagram protocol (UDP) or transport stream (TS) files or HTTP objects over UDP. That is, in order to maintain transparency for the media player 311, an OTT stream received in a multicast format (e.g., RTSP over User Datagram Protocol (UDP) or hypertext markup language (HTML) object over UDP) may be reformatted into a unicast format supported by the media player (e.g., a RTMP over TCP or HLS over TCP format).

In certain implementations, the media player 311 is configured to open a point-to-point connection with an advertisement server 380. This allows advertisements to be placed into OTT content played over the media player 311. The media player 311 further allows collecting data regarding content consumption by a statistics server 390. Such data may include, but is not limited to, bandwidth usage, response time, and so on.

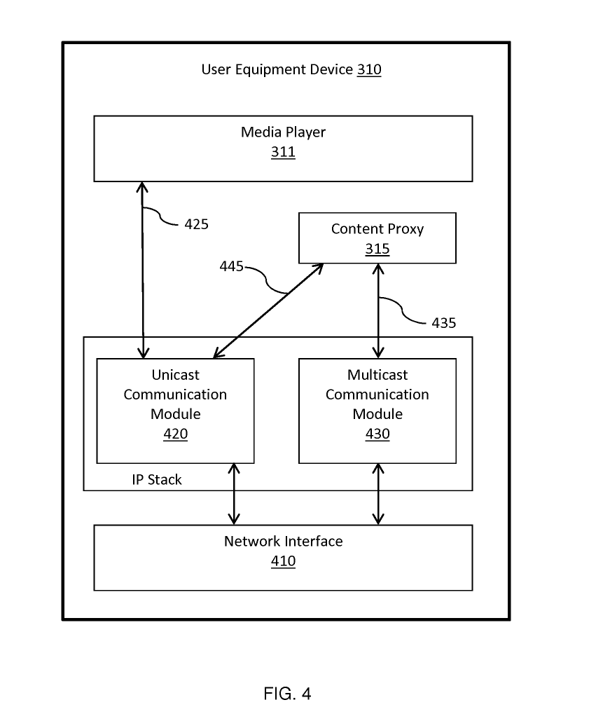

FIG. 4 is a schematic block diagram of the UED 310 for supporting OTT multicast content delivery according to an embodiment. The UED 310 includes a media player 311, a content proxy 315, a TCP (unicast) communication module 420, a UDP (multicast) communication module 430, a network interface 410, and communication sockets 425, 435, and 445.

In an embodiment, the TCP (unicast) and UDP (multicast) communication modules 420 and 430 can be realized as a standard IP stack (or an IP subsystem) of the UED's operating system. Typically, the IP stack enables any application executed by the operating system to send and receive data from the network layer. The application opens a socket on a specific port and uses this socket to send data to the network. The application also listens to the socket in order to receive data from the network. The IP stack receives data from the application, assembles a packet using relevant transport information (e.g., a source IP address, a destination IP address, a source port number, a destination port number, a protocol ID, etc.), and sends the packet to the network interface 410.

The network interface 410 transmits received packets over the broadband network. Similarly, each of the unicast communication module 420 and multicast communication module 430, implemented as an IP stack, receives packets from the network interface 410, analyzes the transport layer information, and sends the data on the appropriate socket to the media player or content proxy.

As noted above, the media player 311 sends a request to initiate a transmission control protocol (TCP) connection with a remote OTT content server (e.g., OTT content server 370) using a streaming protocol. Such a request is sent through the unicast communication module 420 via the network interface.

The request is intercepted and in response, the media player 311 is instructed to redirect the request to the content proxy 315. In an embodiment, such interception may be performed by, but not limited to, an MDS (e.g., the MDS 330, not shown). The media player 311 re-initiates a session via a socket 445 with the content proxy 315 in order to retrieve the OTT content over a point-to-point TCP connection using a streaming protocol supported by the player.

The content proxy 315 is configured to open a UDP connection with a multicast delivery server (e.g., the MDS 330) and to receive an OTT stream in a multicast format. The UDP connection is opened via the multicast communication module 430 and the socket 445.

Multicast communication information is also received through a UDP socket 435 from, e.g., the multicast streaming server. Such information includes a streaming protocol port ID, an IP multicast group, a streaming protocol port ID, and so on. The multicast communication module 430 receives the multicast communication information sent through a network interface 410 of the UED 310. The multicast communication module 430 is configured to de-capsulate the IP headers and send the data to the content proxy 315 over the socket 435.

The content proxy 315 is configured to translate the streams received in a multicast format to a unicast format supported by the media player 311. To this end, the content proxy 315 translates the stream received from the multicast channel (not shown) from a multicast streaming protocol (e.g., RTSP over UDP) to a unicast streaming protocol (e.g., RTMP over TCP) and sends the translated data to the media player 311 via the unicast communication module 420.

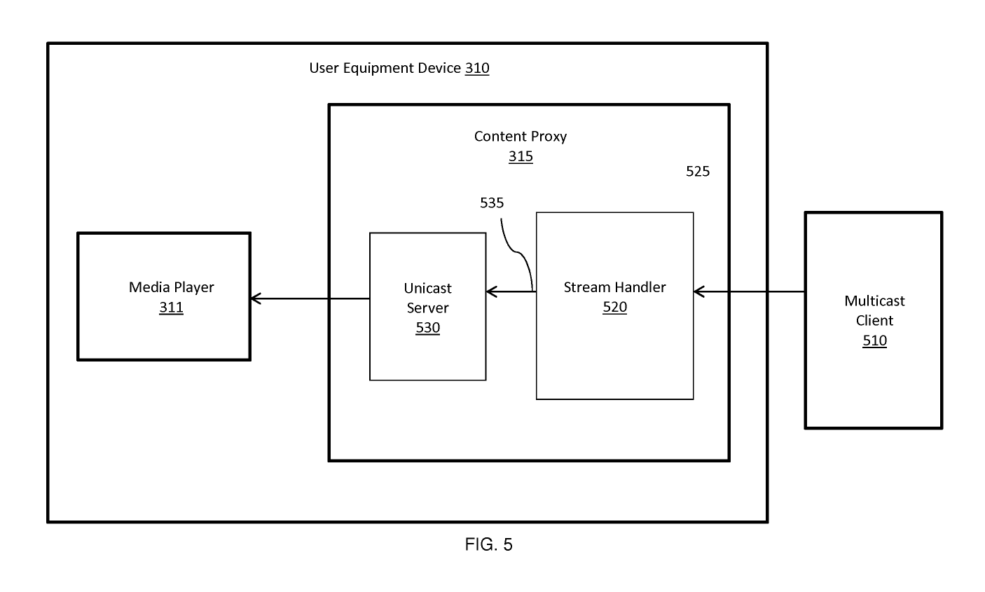

FIG. 5 is an exemplary and non-limiting schematic block diagram of the content proxy 315 according to an embodiment. The content proxy 315 includes a multicast client 510, a stream handler 520, and a unicast server 530 connected to a media player 311. The multicast client 510 is configured to retrieve a multicast OTT stream from a multicast delivery server (e.g., the MDS 330), de-capsulate the streaming protocol headers of the multicast stream, and forward the stream content in its encoded format to the stream handler 520. The streams' contents retrieved by the multicast client 510 include compressed video/audio data without any control information.

The stream handler 520 is configured to convert the stream from its multicast format to a unicast format. The multicast server 530 is configured to encapsulate the audio and video basic streams using unicast streaming protocol headers and to provide the content to the media player 311.

According to one embodiment, the multicast client 510 is a RTSP multicast client and the unicast server 530 is a RTMP server. In this embodiment, the received stream is converted from a RTSP format to a RTMP format. In an exemplary implementation, the conversion into a RTMP format includes terminating the RTSP session, de-capsulating of the data (video/audio), initiating an RTMP session, and encapsulating the data into a RTMP frame format. In another embodiment, the multicast client 510 may be implemented as a HTTP over UDP client and the unicast server 530 is a HLS server. In this embodiment, the received stream is a collection of transport stream (TS) files which are HTTP objects transmitted over the UDP connection. The TS files are extracted from the UDP transport layer and sent to the media player over the TCP connection. Each TS file or object is sent upon reception of a get request from the media player. An example for the operation of the multicast client 510, stream handler 520 and the unicast server 530 can be found in U.S. patent application Ser. No. 14/339,035 filed on Jul. 23, 2014, assigned to the common assignee, and hereby incorporated by reference for all that it contains.

In an embodiment, the multicast client 510 and the unicast server 530 are implemented as generic HTTP client and server, respectively. This allows adapting the disclosed embodiments to support any HTTP streaming protocol. The content proxy 315 receives an HTTP Get request from the player 311 and replies with an HTTP response message with the requested content. The control plan of the HTTP communication between the player 311 and the OTT content server is modified in order to allow delivery of multicast streams to the media player 311. In an exemplary embodiment, at the control plan, when the media player 311 sends a request to a master play list (including the requested TS files) to the OTT content server (or a CDN server), the MDS 330 captures the response from the OTT content server, and modifies the response. The control session is performed between the media player 311 and the OTT content server 370, according to the HTTP based protocol they use to communicate. The content proxy 315 does not participate in the control session.

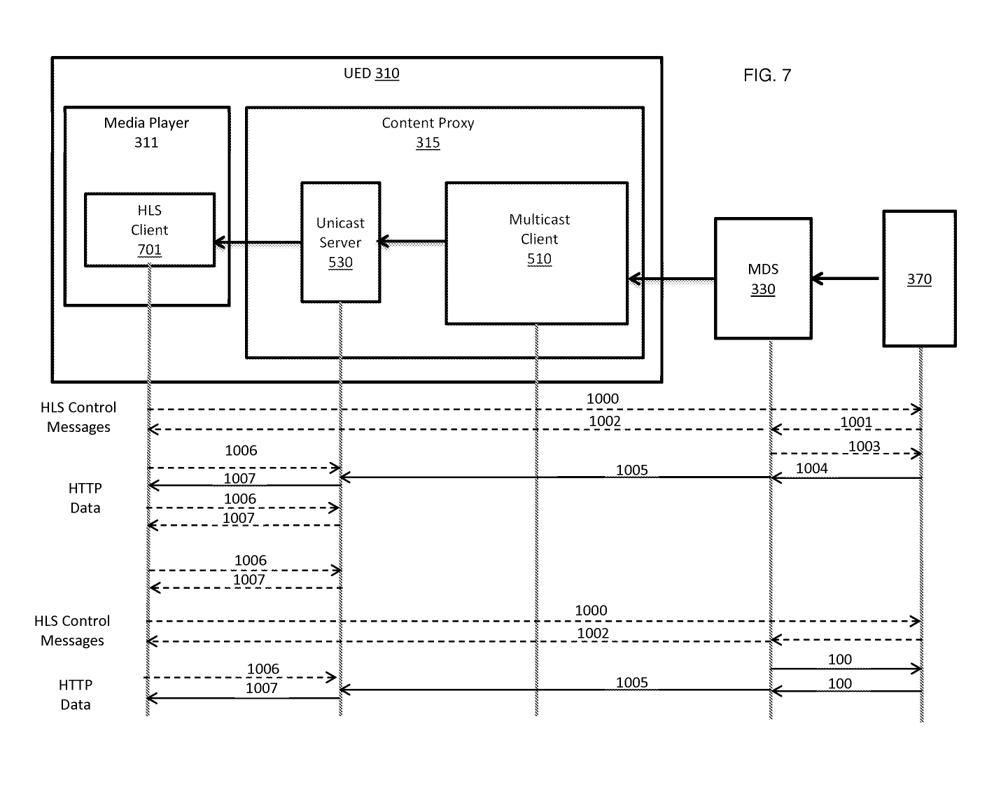

At the data plan, the media player 311 sends an HTTP Get message handled by the server 530 (acting as HTTP server). The server 530 responds with the requested TS files (received from the MDS 330). The operation of this embodiment is discussed in greater detail with reference to FIG. 7.

In some implementations, each of the unicast server 530, the multicast client 510 and the stream handler 520 can be implemented as hardware, software, firmware, or any combination thereof. In an embodiment, the media player 311 can be realized as an add-on or as a plug-in of a web browser. In another embodiment, the media player 311 can be realized as an agent installed in the UED 310. In yet another embodiment, the media player 311 may be realized as a virtual machine executed in such an external system communicatively connected to the UED 310.

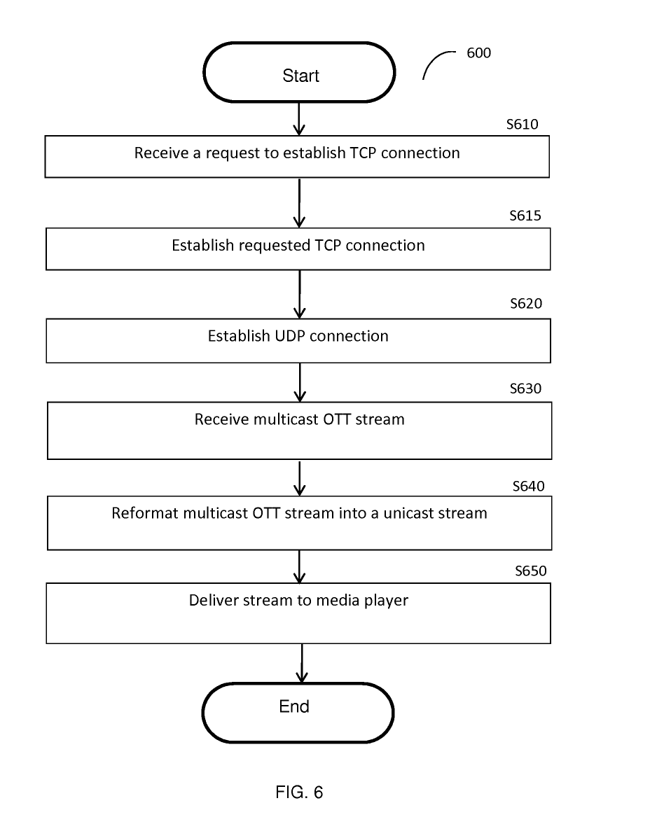

FIG. 6 is an exemplary and non-limiting flowchart 600 illustrating delivery of content in a multicast stream to media players that are not configured to play multicast streams according to an embodiment.

In S610, a request to establish a TCP connection with a media player is received. The request is received in response to initiation of a session between the media player and on OTT content server. In a typical embodiment, the session initiation was intercepted by a multicast delivery server (e.g., the MDS 330), which causes the media player to send the request to the TCP connection. In S615, the TCP connection is established using a streaming protocol that the media player utilizes to communicate with the OTT content server.

In S620, a UDP connection is established with the multicast streaming server. In S630, a multicast OTT stream is received from the multicast delivery server over the UDP connection. The multicast OTT stream may be in a format of HTTP (HTTP objects over UDP), RTSP, and the like.

In S640, the received multicast OTT stream is reformatted into a unicast stream. For example, HTTP objects are reformatted as HSL streams, and RTSP streams are reformatted as RTMP streams. In an embodiment, the decision of which unicast format the stream may be converted into may depend on, for example, the streaming protocol the media player utilizes to communicate with the OTT content server, any unicast format supported by the media player, and so on.

In S650, the stream in its unicast format is delivered to the media player. It should be emphasized that the stream delivery may be seamless, i.e., the unicast format stream may be delivered to the media player such that a viewer of the OTT content being streamed may not be aware of the reformatting. Therefore, the disclosed embodiments allow playing OTT content delivered as a multicast stream without changing existing media players or installing new versions of media players.

In an embodiment, the method discussed with reference to FIG. 6 can be performed by the content proxy 315.

The steps of a method or algorithm described in connection with the embodiments disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in a user equipment device. In the alternative, the processor and the storage medium may reside as discrete components in user equipment. Moreover, in some embodiments, any suitable computer-program product may comprise a computer-readable medium comprising code executable (e.g., executable by at least one computer) to provide functionality relating to one or more of the embodiments of the disclosure. In some embodiments, a computer program product may comprise packaging materials. Furthermore, a non-transitory computer readable medium is any computer readable medium except for a transitory propagating signal.

FIG. 7 illustrates the operation of the content proxy 315 according to another embodiment. In this embodiment, the multicast client 510 and the unicast server 530 are implemented as generic HTTP client and server, respectively. In this implementation, the content proxy 315 is agnostic to a specific HTTP-based streaming protocol (e.g., HLS, HDS, DASH, etc.) being utilized between the player 311 and the content server 370.

According to this embodiment, the control plan, i.e., control messages (1000 and 1001) are handled between the media player 311 and the content server 370. Such messages are protocol dependent. In the exemplary embodiment illustrated in FIG. 7, the media player 311 implements an HLS client.

The MDS 330 (discussed in detail above) is configured to capture the messages exchanged between an HLS client 701 and the content server 370, and to return a modified control message (1002). The content proxy 315 is agnostic to control messages (1000, 1002). The MDS 330 is further configured to fetch the content from the content server 370 (1003, 1004) convert the content to a multicast format and send the multicast stream (1005) over the network over a UDP connection. The HTTP client 510 is configured to retrieve the HTTP objects (TS files over UDP) and push the files to the HTTP server 530.

Once the media player client 701 receives the control message response (1002), the client 701 sends HTTP Get (1006) messages to the HTTP server 530 located at the content proxy 315, the HTTP server responds with an HTTP response message with the requested relevant content file (1007). This call follow continues until the end of the content or user termination.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some embodiments computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some embodiments computer-readable medium may comprise transitory computer readable medium (e.g., comprising a signal). Combinations of the above should also be included within the scope of computer-readable media. It should be appreciated that a computer-readable medium may be implemented in any suitable computer-program product. Although particular embodiments are described herein, many variations and permutations of these embodiments fall within the scope of the disclosure.

Also, it should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

Although some benefits and advantages of the preferred embodiments are mentioned, the scope of the disclosure is not intended to be limited to particular benefits, uses, or objectives. Rather, embodiments of the disclosure are intended to be broadly applicable to different wireless technologies, system configurations, networks, and transmission protocols, some of which are illustrated by way of example in the figures and in the description.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the principles and novel features disclosed herein.

What is claimed is:

1. A method for playing over-the-top (OTT) content streams, comprising:
establishing a transmission control protocol (TCP) connection with a media player;
establishing a user datagram protocol (UDP) connection with a multicast delivery server (MDS);
receiving an OTT content stream in a multicast streaming format via the UDP connection;
reformatting the received multicast OTT content stream into a unicast stream; and
delivering the unicast stream via the TCP connection to the media player, wherein the unicast stream is a streaming format supported by the media player.

2. The method of claim 1, wherein the TCP connection is established using a streaming protocol that the media player communicates with an OTT content server.

3. The method of claim 1, wherein the multicast streaming format is any one of: hypertext transfer protocol (HTTP) objects over UDP and real-time streaming protocol (RTSP).

4. The method of claim 1, wherein the unicast streaming format is any one of: real-time messaging (RTMP) protocol and a HTTP live streaming (HLS) protocol.

5. The method of claim 1, wherein the transition from the multicast streaming format to the unicast streaming format is seamless to the media player.

6. The method of claim 1, wherein the method is performed by a proxy communicatively connected to the media player.

7. The method of claim 1, wherein the proxy is operable in a user equipment device hosting the media player.

8. The method of claim 1, wherein the received OTT content stream is any one of: a replicated OTT content stream, a live OTT content stream, and a linear OTT content stream.

9. A non-transitory computer readable medium having stored thereon instructions for causing one or more processing units to execute the method according to claim 1.

10. A system for playing over-the-top (OTT) content in a multicast streaming format, comprising:
a processor; and
a memory communicatively connected to the processor, the memory containing instructions that, when executed by the processor, configure the system to:
establish a transmission control protocol (TCP) connection with a media player;
establish a user datagram protocol (UDP) connection with a multicast delivery server (MDS);
receive an OTT content stream in a multicast streaming format via the UDP connection;
reformat the received multicast OTT content stream into a unicast stream; and
deliver the unicast stream via the TCP connection to the media player, wherein the unicast stream is a streaming format supported by the media player.

11. The system of claim 10, wherein the TCP connection is established using a streaming protocol that the media player communicates with an OTT content server.

12. The system of claim 10, wherein the multicast streaming format is any one of: hypertext transfer protocol (HTTP) objects over UDP and real-time streaming protocol (RTSP).

13. The system of claim 10, wherein the unicast streaming format is any one of: real-time messaging (RTMP) protocol and a HTTP live streaming (HLS) protocol.

14. The system of claim 10, wherein the transition from the multicast streaming format to the unicast streaming format is seamless to the media player.

15. The system of claim 10, wherein the method is performed by a proxy communicatively connected to the media player.

16. The system of claim 10, wherein the proxy is operable in a user equipment device hosting the media player.

17. The system of claim 10, wherein the received OTT content stream is any one of: a replicated OTT content stream, a live OTT content stream, and a linear OTT content stream.

18. A non-transitory computer readable medium having stored thereon instructions for causing one or more processing units to execute the method according to claim 1.

19. A communication terminal, comprising:
a display;
a processing unit; and
a memory, the memory containing instructions that, when executed by the processing unit, configure the terminal to:
establish a transmission control protocol (TCP) connection with a media player;
establish a user datagram protocol (UDP) connection with a multicast delivery server (MDS);
receive an OTT content stream in a multicast streaming format via the UDP connection;
reformat the received multicast OTT content stream into a unicast stream; and
deliver the unicast stream via the TCP connection to the media player, wherein the unicast stream is a streaming format supported by the media player, thereby enabling the media player to display the contents of the unicast stream over the display.

20. A method for playing over-the-top (OTT) content streams, comprising:
establishing a user datagram protocol (UDP) connection with a multicast delivery server (MDS);
receiving an OTT content stream in a multicast streaming format via the UDP connection;
receiving a request for data content from a media player, wherein the request is a hypertext transfer protocol (HTTP) Get request; and
responding to the request with data content received via the UDP connection.

21. The method of claim 20, wherein the OTT content stream are delivered from its origin using an HTTP-based streaming protocol.
